(19) United States
(12) Patent Application Publication
(10) Pub. No.: US 2025/0306209 A1
(43) Pub. Date: Oct. 2, 2025

(54) LIDAR SENSOR FOR VEHICLES

(71) Applicant: HYUNDAI MOBIS CO., LTD., Seoul (KR)

(72) Inventor: Ju Hyung CHOI, Seongnam-si (KR)

(73) Assignee: HYUNDAI MOBIS CO., LTD., Seoul (KR)

(21) Appl. No.: 18/911,479

(22) Filed: Oct. 10, 2024

(30) Foreign Application Priority Data
Mar. 27, 2024 (KR) 10-2024-0041481

(51) Int. Cl. G01S 17/89; G01S 7/48; G01S 17/50

(52) U.S. Cl. CPC G01S 17/89; G01S 7/4808; G01S 17/50

(57) ABSTRACT

Provided is a light detection and ranging (LiDAR) sensor for vehicles, and more particularly, a LiDAR sensor for vehicles that may correct and generate a point cloud based on a vehicle movement.

### CROSS-REFERENCE TO RELATED APPLICATIONS

This application claims priority under 35 U.S.C. § 119 to Korean Patent Application No. 10-2024-0041481, filed on Mar. 27, 2024, in the Korean Intellectual Property Office, the disclosure of which is incorporated herein by reference in its entirety.

### TECHNICAL FIELD

The following disclosure relates to a light detection and ranging (LiDAR) sensor for vehicles, and more particularly, to a LiDAR sensor for vehicles that may correct and generate a point cloud based on a vehicle movement.

### BACKGROUND

In general, a light detection and ranging (LiDAR) sensor is a device which may accurately depict its surroundings by emitting a laser pulse and receiving light reflected from a surrounding target object to thus measure a distance, a direction, a material, a feature, or the like to the object.

The LiDAR sensor may use a laser that may generate a pulse signal having high energy density and a short period, and thus be used for more precise observation of atmospheric physical properties and distance measurement. In addition, the LiDAR sensor may be classified into a time of flight (ToF) type and a phase-shift (PS) type based on a modulation method of a laser signal.

The ToF method is a method of measuring a distance by emitting the pulse signal from the laser and measuring a time of the pulse signal being reflected and returned from objects within a measurement range, and the PS method is a method of calculating time and distance by emitting a laser beam that is continuously modulated while having a specific frequency and measuring a phase change of the signal reflected and returned from the object within the measurement range.

The LiDAR sensor may be installed and used in a vehicle, and especially used in an autonomous driving field for three-dimensional (3D) high-precision map production, positioning, and recognition algorithms. However, when mounted on the vehicle, a scanning-type LiDAR may encounter an error in data collection, even though the LiDAR may ideally express a 3D space when the vehicle is stationary. In particular, the faster the vehicle is moved, the larger the error that may occur.

### SUMMARY

An embodiment of the present disclosure is directed to providing a LiDAR sensor for vehicles that may provide a more accurate point cloud by correcting a point cloud generated based on a vehicle movement.

In one general aspect, provided is a light detection and ranging (LiDAR) sensor for vehicles, the sensor including: a LiDAR transceiver transmitting a laser pulse signal and receiving a reflected wave; a signal processor generating frame data and time of flight (ToF) data based on the reflected wave, and generating vehicle coordinate data based on vehicle information received from a vehicle; and a point cloud generator generating a point cloud based on the frame data, the ToF data, and the vehicle coordinate data, wherein when coordinates of a pixel are moved, the point cloud generator generates a corrected point cloud by correcting the coordinates of the pixel based on coordinates reflecting a vehicle movement during a time taken for the coordinates of the pixel to be moved based on pixel information included in the frame data.

The LiDAR transceiver may transmit the laser pulse signal emitted in a first direction (j), and perform a scan in a second direction (i) vertical to the first direction (j), and when a first pixel included in the frame data is moved by m in the second direction (i), the signal processor may correct the first pixel based on the coordinates reflecting the vehicle movement during a time taken for the first pixel to be moved, in consideration of the time taken for the first pixel to be moved by m.

When point cloud coordinates of the first pixel are (X_{i,j}, Y_{i,j}, Z_{i,j}) and the vehicle coordinates are (Vₓ, V_{y}, V_{z}), the signal processor may correct the point cloud coordinates of the first pixel moved by m in the second direction after a predetermined time T to (X_{i+m,j+n}−Vₓ*mT, Y_{i+m,j+n}−V_{y}*mT, Z_{i+m,j+n}−V_{z}*mT), where n is a value by which the first pixel is moved in the first direction.

When correcting the first pixel based on a time of acquiring all the frame data, the signal processor may correct point cloud coordinates of the first pixel to (X_{i+m,j+n}+Vₓ*mT, Y_{i+m,j+n}+V_{y}*mT, Z_{i+m,j+n}+V_{z}*mT), where n is a value by which the first pixel is moved in the first direction.

The LiDAR transceiver may transmit the laser pulse signal emitted in a second direction (i), and perform a scan in a first direction (j) vertical to the second direction (i), and when a second pixel included in the frame data is moved by n in the first direction (j), the signal processor may correct the second pixel based on the coordinates reflecting the vehicle movement during a time taken for the second pixel to be moved, in consideration of the time taken for the second pixel to be moved by n.

When point cloud coordinates of the second pixel are (X_{i,j}, Y_{i,j}, Z_{i,j}) and the vehicle coordinates are (Vₓ, V_{y}, V_{z}), the signal processor may correct the point cloud coordinates of the second pixel moved by n in the first direction after a predetermined time T, to (X_{i+m ,j+n}−Vₓ*nT, Y_{i+m,j+n}−V_{y}*nT, Z_{i+m,j+n}−V_{z}*nT), where m is a value by which the second pixel is moved in the second direction.

When correcting the second pixel based on a time of acquiring all the frame data, the signal processor may correct point cloud coordinates of the second pixel to (X_{i+m,j+n}+Vₓ*nT, Y_{i+m,j+n}+V_{y}*nT, Z_{i+m,j+n}+V_{z}*nT), where m is a value by which the second pixel is moved in the second direction.

The point cloud generator may generate the corrected point cloud by comparing first frame data with second frame data received after the first frame data, and correcting pixels included in the first frame data based on the coordinates reflecting the vehicle movement during a time from when receiving the first frame data until receiving the second frame data.

The signal processor may calculate and accumulate the vehicle coordinate data for a predetermined time based on vehicle speed information and vehicle driving direction information included in the vehicle information.

The point cloud generator may generate the corrected point cloud by correcting the coordinates of each pixel included in the frame data by reflecting a change in the vehicle coordinate data based on the vehicle speed information and the vehicle driving direction information.

Other features and aspects will be apparent from the following detailed description, the drawings, and the claims.

### BRIEF DESCRIPTION OF THE DRAWINGS

FIG. 1 is a configuration diagram showing a light detection and ranging (LiDAR) sensor for vehicles according to an embodiment of the present disclosure.

FIG. 2 is an example diagram showing a method of correcting a point cloud when a scanning direction of the LiDAR sensor is a second direction (i) according to an embodiment of the present disclosure.

FIG. 3 is an example diagram showing a method of correcting a point cloud when the scan direction of the LiDAR sensor is a first direction (j) according to an embodiment of the present disclosure.

### DETAILED DESCRIPTION OF EMBODIMENTS

The above-mentioned objects, features, and advantages will become more obvious from the following embodiments provided in relation to the accompanying drawings. The following descriptions of specific structures and functions are provided only to describe the embodiments based on a concept of the present disclosure. Therefore, the embodiments of the present disclosure may be implemented in various forms, and the present disclosure is not limited thereto. The embodiments of the present disclosure may be variously modified and may have several forms, and specific embodiments are thus shown in the accompanying drawings and described in detail in the specification or the present application. However, it is to be understood that the present disclosure is not limited to the specific embodiments, and includes all modifications, equivalents, and substitutions, included in the spirit and scope of the present disclosure. Terms such as “first” or “second” may be used to describe various components, and the components are not to be construed as being limited to the terms. The terms are used only to distinguish one component and another component from each other. For example, a “first” component may be named a “second” component and the “second” component may also be named the “first” component, without departing from the scope of the present disclosure. It is to be understood that when one component is referred to as being “connected to” or “coupled to” another component, the corresponding component may be connected or coupled directly to another component or connected or coupled to another component with a third component interposed therebetween. On the other hand, it is to be understood that when one component is referred to as being “connected directly to” or “coupled directly to” another component, one component may be connected to or coupled to another component without a third component interposed therebetween. Other expressions to describe a relationship between the components, i.e., “˜between” and “directly between” or “adjacent to” and “directly adjacent to”, should be interpreted in the same manner as above. Terms used in the specification are used only to describe the specific embodiments rather than limiting the present disclosure. A term of a single number may include its plural number unless explicitly indicated otherwise in the context. In addition, it is to be understood that a term “include”, “formed of”, or the like used in the specification specifies the existence of features, numerals, steps, operations, components, parts, or combinations thereof, which are described and shown herein, and does not preclude the existence or addition of one or more other features, numerals, steps, operations, components, parts, or combinations thereof. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. Hereinafter, the present disclosure will be described in detail by describing a preferred embodiment of the present disclosure with reference to the accompanying drawings. The same reference numerals in each drawing indicate the same member.

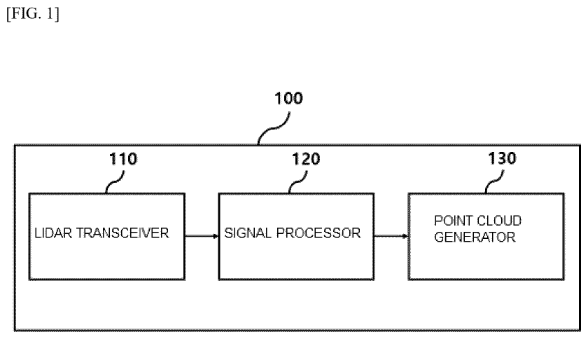

FIG. 1 is a configuration diagram showing a light detection and ranging (LiDAR) sensor for vehicles according to an embodiment of the present disclosure.

Referring to FIG. 1, a LiDAR sensor 100 for vehicles according to an embodiment of the present disclosure may include a LiDAR transceiver 110, a signal processor 120, and a point cloud generator 130. The LiDAR sensor 100 for vehicles according to the embodiment of the present disclosure may be used in a typical vehicle such as an automobile, an airplane, or a train, and especially used in an autonomous vehicle.

The LiDAR transceiver 110 may transmit a LiDAR pulse signal and receive a reflected wave that is generated and returned when the transmitted LiDAR pulse signal touches an object. The LiDAR transceiver 110 may be rotated while including a motor, transmit a laser pulse signal emitted in a first direction (j), which is vertical to ground, and perform a scan while being rotated in a second direction (i), which is vertical to the first direction (j). When scanning once in the second direction (i), the LiDAR transceiver 110 may set the reflected wave to 1 frame and transmit the same to the signal processor 120. In addition, the LiDAR transceiver 110 may include a 1D addressable vertical-cavity surface-emitting laser (VCSEL). The LiDAR transceiver 110 may transmit the laser pulse signal emitted in the second direction (i), which is horizontal to the ground, and perform the scan in the first direction (j), which is vertical to the second direction (i).

The signal processor 120 may generate frame data and time of flight (ToF) data based on the reflected wave received from the LiDAR transceiver 110, and generate vehicle coordinate data based on vehicle information received from the vehicle. The signal processor 120 may receive information, such as a vehicle speed and a vehicle driving direction, from the vehicle, and calculate and accumulate the vehicle coordinate data for a predetermined time to be used by the point cloud generator 130 based on the received information.

The point cloud generator 130 may generate a point cloud based on the frame data, the ToF data, and the vehicle coordinate data, generated by the signal processor 120. When coordinates of a pixel are moved within 1 frame, the point cloud generator 130 may generate a corrected point cloud by correcting the coordinates of the pixel based on coordinates reflecting a vehicle movement during a time taken for the coordinates of the pixel to be moved, based on pixel information indicating the coordinates of each pixel included in the frame data.

In addition, the point cloud generator 130 may generate the corrected point cloud by comparing first frame data with second frame data received after the first frame data, and correcting pixels included in the first frame data based on the coordinates reflecting the vehicle movement during a time from when receiving the first frame data until receiving the second frame data.

In addition, the point cloud generator 130 may generate the corrected point cloud by correcting the coordinates of each pixel included in the frame data by reflecting a change in the vehicle coordinate data based on the vehicle coordinate data generated by the signal processor 120.

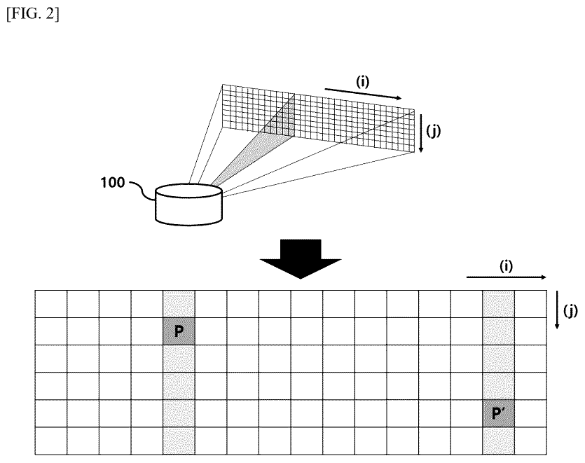

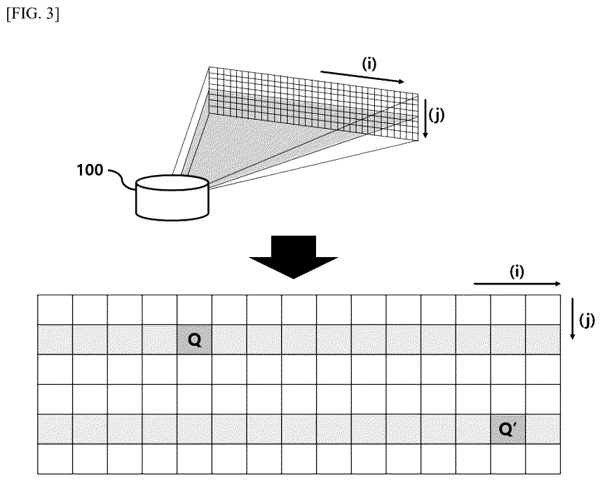

Hereinafter, the description describes a method of generating the corrected point cloud by the point cloud generator 130 in detail with reference to FIGS. 2 and 3.

FIG. 2 is an example diagram showing the method of correcting a point cloud when the scanning direction of the LiDAR sensor is the second direction (i) according to an embodiment of the present disclosure.

Referring to FIG. 2, the LiDAR sensor 100 according to an embodiment of the present disclosure may include the LiDAR transceiver 110 which is rotated while including the motor, transmits the laser pulse signal emitted in the first direction (j), which is vertical to the ground, and performs the scan while being rotated in the second direction (i), which is vertical to the first direction (j).

The LiDAR transceiver 110 may transmit the laser pulse signal emitted in the first direction (j), and perform the scan in the second direction (i) vertical to the first direction (j), and when a first pixel P included in the frame data is moved by m in the second direction (i), the point cloud generator 130 may correct the first pixel P or a pixel P′ to which the first pixel is moved based on the coordinates reflecting the vehicle movement during a time taken for the first pixel P to be moved, in consideration of the time taken for the first pixel P to be moved by m. The LiDAR transceiver 110 may emit the laser pulse signal in the first direction (j) while being rotated in the second direction (i). Therefore, there is no problem in detecting the same first pixel P in the second direction (i). However, due to the vehicle movement, the first pixel P may be detected by being moved in the first direction (j). Here, m and n values may be 0, which indicates that these values include both of a movement on the same axis and a three-dimensional movement regardless of an axis along which the vehicle is moved.

The point cloud generator 130 may calculate each time of receiving when the first pixel P and the pixel P′, in which the first pixel is moved by n in the first direction (j) and by m in the second direction (i), based on the ToF data, and determine the vehicle movement during the corresponding time, thereby correcting the first pixel P. The point cloud generator 130 may generate point cloud coordinates by converting the first pixel P into 3D coordinates. When the point cloud coordinates of the first pixel P are (X_{i,j}, Y_{i,j}, Z_{i,j}) and the vehicle coordinates are (Vₓ, V_{y}, V_{z}), the point cloud generator 130 may correct point cloud coordinates of the first pixel P′, in which the first pixel is moved by m in the second direction (i) after a predetermined time T, to (X_{i+m,j+n}−Vₓ*mT, Y_{i+m,j+n}−V_{y}*mT, Z_{i+m,j+n}−V_{z}*mT), where n may be a value by which the first pixel is moved in the first direction (j).

In addition, when correcting the first pixel P based on a time of acquiring all the frame data, the point cloud generator 130 may correct the point cloud coordinates of the first pixel P to (X_{i+m,j+n}+Vₓ*mT, Y_{i+m,j+n}+V_{y}*mT, Z_{i+m,j+n}+V_{z}*mT), where m may be a value by which the first pixel is moved in the second direction (i).

Referring to FIG. 3, the LiDAR sensor 100 according to embodiments of the present disclosure may include the LiDAR transceiver 110 which includes a 1D addressable vertical-cavity surface-emitting laser (VCSEL), transmits the laser pulse signal emitted in the second direction (i), which is horizontal to the ground, and performs the scan in the second direction (i), which is vertical to the first direction (j).

The LiDAR transceiver 110 may transmit the laser pulse signal emitted in the second direction (i), and perform the scan in the first direction (j) vertical to the second direction (i), and when a second pixel Q included in the frame data is moved by n in the first direction (j), the point cloud generator 130 may correct the second pixel Q or a pixel Q′ to which the second pixel is moved based on the coordinates reflecting the vehicle movement during a time taken for the second pixel Q to be moved, in consideration of the time taken for the second pixel Q to be moved by n. The LiDAR transceiver 110 may emit the laser pulse signal in the second direction (i), and perform the scan in the first direction (j). Therefore, there is no problem in detecting the same second pixel Q in the first direction (j). However, due to the vehicle movement, the second pixel Q may be detected by being moved in the second direction (i). Here, the m and n values may be 0, which indicates that these values include both of the movement on the same axis and the three-dimensional movement regardless of the axis along which the vehicle is moved.

The point cloud generator 130 may calculate each time of receiving when the second pixel Q and the pixel Q′, in which the second pixel is moved by n in the first direction (j) and by m in the second direction (i), based on the ToF data, and determine the vehicle movement during the corresponding time, thereby correcting the second pixel Q. The point cloud generator 130 may generate point cloud coordinates by converting the second pixel Q into 3D coordinates. When the point cloud coordinates of the second pixel Q are (X_{i,j}, Y_{i,j}, Z_{i,j}) and the vehicle coordinates are (Vₓ, V_{y}, V_{z}), the point cloud generator 130 may correct point cloud coordinates of the second pixel Q′, in which the second pixel is moved by n in the first direction (j) after the predetermined time T, to (X_{i+m,j+n}−Vₓ*nT, Y_{i+m,j+n}−V_{y}*nT, Z_{i+m,j+n}−V_{z}*nT), where m may be a value by which the second pixel is moved in the second direction (i).

In addition, when correcting the second pixel Q based on the time of acquiring all the frame data, the point cloud generator 130 may correct the point cloud coordinates of the second pixel Q to (X_{i+m,j+n}+Vₓ*nT, Y_{i+m,j+n}+V_{y}*nT, Z_{i+m,j+n}+V_{z}*nT), where m may be a value by which the second pixel is moved in the second direction (i).

The present disclosure can also be embodied as computer readable code or software stored on a computer-readable recording medium such as a non-transitory computer-readable recording medium. Examples of the computer readable recording medium include a hard disk drive (HDD), a solid state drive (SSD), a silicon disc drive (SDD), read-only memory (ROM), random-access memory (RAM), CD-ROM, magnetic tapes, floppy disks, optical data storage devices, etc.

The point cloud generator 130 may be implemented as a computer, a processor, a microprocessor, or may include a processor or a microprocessor. When the computer, the processor, or the microprocessor reads and executes the computer readable code stored in the computer-readable recording medium, the point cloud generator 130 may be configured to perform the above-described operations/method. Similarly, when the signal processor 120 reads and executes the computer readable code stored in the computer-readable recording medium, the signal processor 120 may be configured to perform the above-described operations/method. In one example, the signal processor 120 and the point cloud generator 130 may include a storage or memory configured as a computer-readable recording medium storing the computer readable code or software.

As set forth above, the LiDAR sensor according to the present disclosure may provide the more accurate point cloud even when the vehicle is moved.

In addition, the LiDAR sensor according to the present disclosure may correct the point cloud based on the vehicle movement regardless of the scanning method of the LiDAR sensor.

In addition, the LiDAR sensor according to the present disclosure may determine the points which may be misidentified as noise as a greater error occurs in the point cloud data based on the vehicle movement, as the ground truth values by its correction, thereby preventing the data loss that may occur due to the noise filtering.

In addition, the LiDAR sensor according to the present disclosure may minimize the influence of the vehicle from which the sensor acquires the data when generating the point cloud map used in the LiDAR-based positioning. In addition, the LiDAR sensor according to the present disclosure may enable the accurate positioning in the subsequent positioning stages.

In addition, the LiDAR sensor according to the present disclosure may perform the correction based on the vehicle location in the point cloud generation stage, thus making the post-processing such as filtering and calibration easier.

Although the embodiments of the present disclosure are described as above, the embodiments disclosed in the present disclosure are provided not to limit the spirit of the present disclosure, but to fully describe the present disclosure. Therefore, the spirit of the present disclosure may include not only each disclosed embodiment but also a combination of the disclosed embodiments. Further, the scope of the present disclosure is not limited to these embodiments. That is, it is apparent to those skilled in the art to which the present disclosure pertains that various variations and modifications could be made without departing from the spirit and scope of the appended claims, and all such appropriate variations and modifications should be considered as falling within the scope of the present disclosure as equivalents.

What is claimed is:

1. A light detection and ranging (LiDAR) sensor for a vehicle, the sensor comprising:
a LiDAR transceiver configured to transmit a laser pulse signal and receive a reflected wave;
a signal processor configured to generate frame data and time of flight (ToF) data based on the reflected wave, and generate vehicle coordinate data based on vehicle information received from the vehicle; and
a point cloud generator configured to generate a point cloud based on the frame data, the ToF data, and the vehicle coordinate data,
wherein when coordinates of a pixel are moved, the point cloud generator is configured to generate a corrected point cloud by correcting the coordinates of the pixel based on coordinates reflecting a vehicle movement during a time taken for the coordinates of the pixel to be moved, based on pixel information included in the frame data.

2. The sensor of claim 1, wherein the LiDAR transceiver is configured to transmit the laser pulse signal emitted in a first direction (j), and to perform a scan in a second direction (i) vertical to the first direction (j), and
when a first pixel included in the frame data is moved by m in the second direction (i), the signal processor is configured to correct the first pixel based on the coordinates reflecting the vehicle movement during a time taken for the first pixel to be moved, in consideration of the time taken for the first pixel to be moved by m.

3. The sensor of claim 2, wherein when point cloud coordinates of the first pixel are (X_{i,j}, Y_{i,j}, Z_{i,j}) and the vehicle coordinates are (Vₓ, V_{y}, V_{z}), the signal processor is configured to correct the point cloud coordinates of the first pixel moved by m in the second direction after a predetermined time T to (X_{i+m,j+n}−Vₓ*mT, Y_{i+m,j+n}−V_{y}*mT, Z_{i+m,j+n}−V_{z}*mT), where n is a value by which the first pixel is moved in the first direction.

4. The sensor of claim 2, wherein when correcting the first pixel based on a time of acquiring all the frame data, the signal processor is configured to correct point cloud coordinates of the first pixel to (X_{i+m,j+n} +Vₓ*mT, Y_{i+m,j+n}+V_{y}*mT, Z_{i+m,j+n}+V_{z}*mT), where n is a value by which the first pixel is moved in the first direction.

5. The sensor of claim 1, wherein the LiDAR transceiver is configured to transmit the laser pulse signal emitted in a second direction (i), and to perform a scan in a first direction (j) vertical to the second direction (i), and when a second pixel included in the frame data is moved by n in the first direction (j), the signal processor is configured to correct the second pixel based on the coordinates reflecting the vehicle movement during a time taken for the second pixel to be moved, in consideration of the time taken for the second pixel to be moved by n.

6. The sensor of claim 5, wherein when point cloud coordinates of the second pixel are (X_{i,j}, Y_{i,j}, Z_{i,j}) and the vehicle coordinates are (Vₓ, V_{y}, V_{z}), the signal processor is configured to correct the point cloud coordinates of the second pixel moved by n in the first direction after a predetermined time T, to (X_{i+m,j+n}−Vₓ*nT, Y_{i+m,j+n}−V_{y}*nT, Z_{i+m,j+n}−V_{z}*nT), where m is a value by which the second pixel is moved in the second direction.

7. The sensor of claim 5, wherein when correcting the second pixel based on a time of acquiring all the frame data, the signal processor is configured to correct point cloud coordinates of the second pixel to (X_{i+m,j+n}+Vₓ*nT, Y_{i+m,j+n}+V_{y}*nT, Z_{i+m,j+n}+V_{z}*nT), where m is a value by which the second pixel is moved in the second direction.

8. The sensor of claim 1, wherein the point cloud generator is configured to generate the corrected point cloud by comparing first frame data with second frame data received after the first frame data, and correcting pixels included in the first frame data based on the coordinates reflecting the vehicle movement during a time from when receiving the first frame data until receiving the second frame data.

9. The sensor of claim 1, wherein the signal processor is configured to calculate and accumulate the vehicle coordinate data for a predetermined time based on vehicle speed information and vehicle driving direction information included in the vehicle information.

10. The sensor of claim 9, wherein the point cloud generator is configured to generate the corrected point cloud by correcting the coordinates of each pixel included in the frame data by reflecting a change in the vehicle coordinate data based on the vehicle speed information and the vehicle driving direction information.
